(19) United States
(12) Patent Application Publication
(10) Pub. No.: US 2016/0368409 A1
(43) Pub. Date: Dec. 22, 2016

(54) Folding Dolly for Towing a Vehicle

(71) Applicant: Frank Ward, Wayne, MI (US)

(72) Inventor: Frank Ward, Wayne, MI (US)

(21) Appl. No.: 15/185,386

(22) Filed: Jun. 17, 2016

Related U.S. Application Data
(60) Provisional application No. 62/180,784, filed on Jun. 17, 2015.

(51) Int. Cl. B60P 3/077; B62D 63/06; B60D 1/155

(52) U.S. Cl. CPC B60P 3/077; B60D 1/155; B62D 63/061; B62D 63/062

(57) ABSTRACT

A folding dolly for towing a vehicle provides two rectangular wheel cradles, which secure the front wheels of the vehicle to be towed, and are joined by a cross member. A two-piece tongue extends forward from the center of the cross member. One leading corner of each wheel cradle is joined to the tongue with a diagonal steering arm. Each wheel cradle also provides a removable wheel. Most of the components of the dolly provide a telescoping feature, such that they may be collapsed into a compact length for storage, then extended to fit the vehicle to be towed, and locked into position.

### CROSS-REFERENCE TO RELATED APPLICATIONS

This Application claims the benefit of U.S. Provisional Application No. 62/180,784, filed Jun. 17, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to towing equipment and in particular to a folding dolly for towing a vehicle. Occasionally, the owner of a conventional vehicle finds it necessary to tow another vehicle. Tow bars are available, but are heavy, cumbersome, and difficult to use, with structures which may not be compatible with the bumpers of newer vehicles. A towing dolly which fits around the front wheels of the towed vehicle is much easier to use, but is even larger and more cumbersome than a tow bar. A folding dolly for towing a vehicle, which provides ease of operation in a compact folding configuration, would resolve this problem.

### SUMMARY OF THE INVENTION

Accordingly, the invention is directed to a folding dolly for towing a vehicle. The dolly provides two rectangular wheel cradles, which secure the front wheels of the vehicle to be towed, and are joined by a cross member. A two-piece tongue extends forward from the center of the cross member. One leading corner of each wheel cradle is joined to the tongue with a diagonal steering arm. Each wheel cradle also provides a removable wheel. Most of the components of the dolly provide a telescoping feature, such that they may be collapsed into a compact length for storage, then extended to fit the vehicle to be towed, and locked into position.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment, displaying the dolly 10, the wheel cradles 11, the jack points 11A, the cross member 12, the tongue 13, the steering arm 14, the wheels 15, and the joints 16.

FIG. 2 is a side transparency view of the first exemplary embodiment, displaying the dolly 10, a wheel cradle 11, the tongue 13, a steering arm 14, and a wheel 15.

FIG. 3 is a side perspective view of the first exemplary embodiment, displaying the dolly 10, the wheel cradles 11, the cross member 12, the tongue 13, the steering arm 14, the wheels 15, and the joints 16.

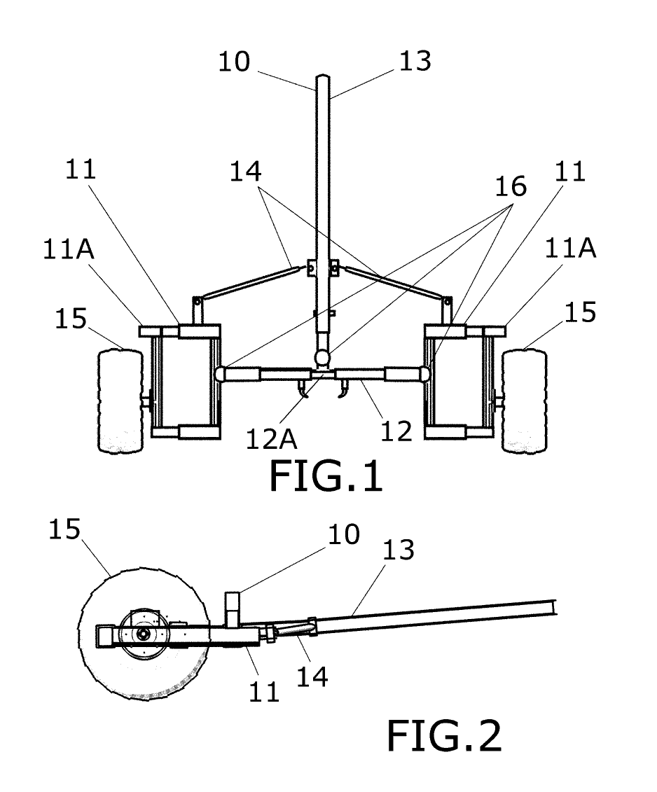

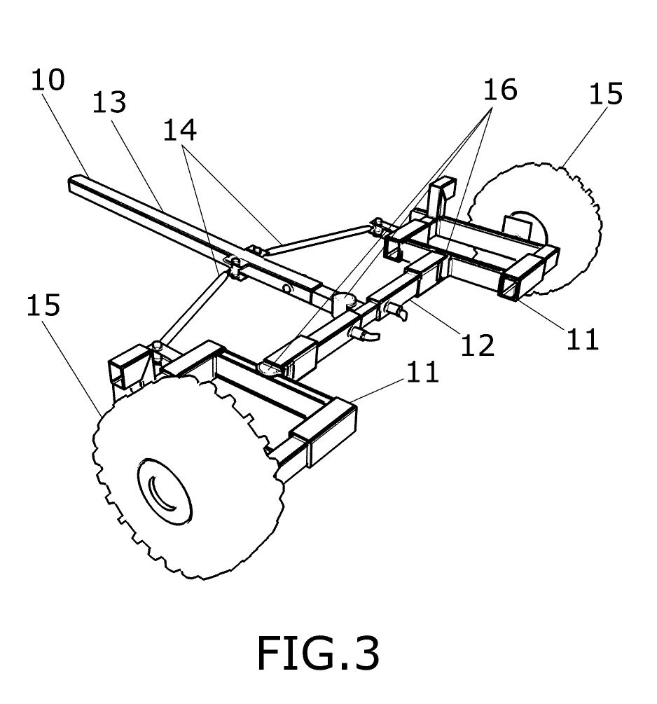

### DETAILED DESCRIPTION OF THE INVENTION

Referring now to the invention in more detail, the invention is directed to a folding dolly 10 for towing a vehicle.

The first exemplary embodiment is comprised of a towing dolly 10 which provides two rectangular wheel cradles 11, which secure the front wheels of the vehicle to be towed, and are joined by a cross member 12. A two-piece tongue 13 extends forward from the center 12A of the cross member 12. One leading corner of each wheel cradle 11 is joined to the tongue 13 with a diagonal steering arm 14. Each wheel cradle 11 also provides a removable wheel 15.

Jack points 11A are provided on the outer front corners of the wheel cradles 11, where a jack may be safely placed for lifting the dolly 10 with a vehicle secured to it. Joints 16, such as knuckle joints or ball and socket joints, are also provided at key points on the frame, enabling the dolly 10 to flex or twist slightly when towing a vehicle over an obstacle, such as a curb. Optionally, additional features such as fenders and electrically powered brakes may be provided.

Removable safety straps are provided for the purpose of securing the front wheels of the vehicle to be towed within the wheel cradles 11. A full wiring harness with magnetic taillight assemblies is also provided, which may be plugged into a socket provided on the trailer hitch of the towing vehicle. The taillight assemblies provide taillights, brake lights, and turn signals which may be magnetically affixed to the trunk lid of the vehicle.

Most of the components of the dolly 10 provide a telescoping feature, such that they may be collapsed into a compact length for storage, then extended to fit the vehicle to be towed, and locked into position. The dolly 10 is preferably capable of towing any vehicle up to 4900 pounds curb weight, and is capable of folding down to no larger than 2 feet in width and 3 feet in length, such that it may easily be stored in the trunk of any subcompact car. The dolly 10 preferably weighs no more than 180 pounds, with between 25 pounds and 100 pounds of tongue weight, enabling almost any adult to operate it.

To use the first exemplary embodiment, the user may back up the towing vehicle to a position in front of the vehicle to be towed, jack up the front end of the vehicle to be towed, and unfold and extend the dolly 10 beneath the front wheels of the vehicle to be towed, such that each front wheel of the vehicle to be towed fits within a wheel cradle 11.

The user may tighten and lock the telescoping components of the dolly 10, such that the wheel cradles 11 fit tightly on the vehicle to be towed, and unfold the wheels 15 and lock them into position. The user may then affix the safety straps to the wheel cradles 11, such that the front wheels of the vehicle to be towed are secured within the wheel cradles 11, and lower the front end of the vehicle to be towed, such that the wheels 15 are resting on the ground. Finally, the user may affix the tongue 13 to the trailer hitch of the towing vehicle, plug the wiring dolly into the socket on the trailer hitch, and magnetically affix the taillight assemblies to the trunk lid of the vehicle to be towed. The user may then commence towing the vehicle to be towed.

The wheel cradles 11, the cross member 12, the tongue 13, and the steering arms 14 are preferably manufactured from a rigid, durable material which is corrosion resistant and provides substantial structural strength, such as stainless steel or aluminum alloy. The wheels 15 are preferably manufactured from a rigid, durable material which is corrosion resistant and provides substantial structural strength, such as stainless steel or aluminum alloy.

The safety straps are preferably manufactured from a flexible, durable material with substantial strength, such as leather or nylon webbing. The wiring dolly is preferably manufactured from braided copper alloy wire sheathed in plastic. The taillight assemblies are preferably manufactured from a rigid, durable material such as steel, providing lenses which are preferably manufactured from a rigid, durable material which is translucent, such as plastic or methacrylate.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A folding dolly, comprising:
a. a towing dolly having two rectangular wheel cradles;
b. said two rectangular wheel cradles providing a telescoping function such that the two rectangular wheel cradles can be widened or lengthened;
c. a telescoping cross member having a center;
d. said cross member providing a telescoping function such that the cross member can be extended or shortened;
e. said cross member joining said two rectangular wheel cradles and being secured to said two rectangular wheel cradles at cradle joints;
f. a two-piece tongue;
g. said two-piece tongue providing a telescoping function such that the two-piece tongue can be extended or shortened;
h. said two-piece tongue being secured to the center of said cross member at a tongue joint;
i. two wheels;
j. each wheel being attached to one of said wheel cradles.
